(19) United States
(12) Patent Application Publication
(10) Pub. No.: US 2010/0225123 A1
(43) Pub. Date: Sep. 9, 2010

(54) LATCH-BOLT MECHANISM WITH A DISTANCE-ADJUSTING DEVICE

(75) Inventors: Wei-Liang Chiang, Chiayi City (TW); Kun-Chen Lee, Chiayi County (TW); Yu-Le Lin, Yunlin County (TW); Lan-Kun Don, Chiayi City (TW); Song-Gen Shyu, Chiayi County (TW); Ching-Chuan Kuo, Chiayi County (TW)

Correspondence Address: LADAS & PARRY LLP, 224 SOUTH MICHIGAN AVENUE, SUITE 1600, CHICAGO, IL, 60604, US

(73) Assignee: TONG LUNG METAL INDUSTRY CO., LTD., Chia-Yi City (TW)

(21) Appl. No.: 12/718,411

(22) Filed: Mar. 5, 2010

(30) Foreign Application Priority Data
Mar. 6, 2009 (TW) 098203569

(51) Int. Cl. E05C 1/08

(52) U.S. Cl. 292/1.5

(57) ABSTRACT

A latch-bolt mechanism includes a housing, a latch-bolt, and a distance-adjusting device. The latch-bolt is movable relative to the housing between an extended position and a retracted position. The distance-adjusting device includes a movable unit movable in the housing between first and second vertical positions and including a first drive member for driving movement of the latch-bolt from the extended position to the retracted position when the movable unit is disposed at either the first or second vertical positions, and a fastener unit for locking the movable unit releaseably at a selected one of the first and second vertical positions.

### CROSS-REFERENCE TO RELATED APPLICATION

This application claims priority of Taiwanese Application No. 098203569, filed on Mar. 6, 2009.

### BACKGROUND OF THE INVENTION

1. Field of the Invention

This invention relates to a latch-bolt mechanism, and more particularly to a latch-bolt mechanism that includes a distance-adjusting device operable to change the distance between a lockset-mounting hole and a driving rod.

2. Description of the Related Art

A movable door latch-bolt can be driven by a handle, a lockset, or a rotary knob to move a latch-bolt between an extended position and a retracted position. When the latch-bolt is mounted to a door, the central axis of a lockset-mounting hole in the door is spaced apart from the central axis of a driving rod, which is operable to move the latch-bolt, by a distance. Since the distance has two commercial standard specifications, i. e. 92 mm and 98.4 mm, it is desirable to provide an adjusting device operable to adjust the distance.

### SUMMARY OF THE INVENTION

The object of this invention is to provide a latch-bolt mechanism with a distance-adjusting device that is operable to adjust the distance between a lockset-mounting hole and a driving rod that is used to drive a latch-bolt.

Accordingly, a latch-bolt mechanism of this invention includes a housing, a latch-bolt, and a distance-adjusting device. The latch-bolt is disposed movably on the housing, and is movable relative to the housing between an extended position and a retracted position. The distance-adjusting device includes a movable unit movable in the housing between first and second vertical positions and including a first drive member for driving movement of the latch-bolt from the extended position to the retracted position when the movable unit is disposed at either the first or second vertical positions, and a fastener unit for locking the movable unit releaseably at a selected one of the first and second vertical positions.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a partly exploded perspective view of the preferred embodiment of a latch-bolt mechanism according to this invention;

FIG. 2 is a fragmentary, partly exploded perspective view of the preferred embodiment;

FIG. 3 is an exploded perspective view of a movable unit of the preferred embodiment;

FIG. 4 is an exploded perspective view of the movable unit of the preferred embodiment, viewed at another angle;

FIG. 5 is a fragmentary schematic view of the preferred embodiment, illustrating how a movable unit is disposed at a first vertical position and how a latch-bolt is disposed at an extended position;

FIG. 6 is a fragmentary schematic view of the preferred embodiment, illustrating how the movable unit is disposed at the first vertical position and how the latch-bolt is moved by a first driven member to a retracted position;

FIG. 7 is a fragmentary schematic view of the preferred embodiment, illustrating how the movable unit is disposed at the first vertical position and how the latch-bolt is moved by a second driven member to the retracted position;

FIG. 8 is a fragmentary schematic view of the preferred embodiment, illustrating how the movable unit is disposed at a second vertical position and how the latch-bolt is disposed at the extended position;

FIG. 9 is a fragmentary schematic view of the preferred embodiment, illustrating how the movable unit is disposed at the second vertical position and how the latch-bolt is moved by the first driven member to the retracted position; and

FIG. 10 is a fragmentary schematic view of the preferred embodiment, illustrating how the movable unit is disposed at the second vertical position and haw the latch-bolt is moved by the second driven member to the retracted position; and

FIG. 11 shows a modified movable unit.

### DETAILED DESCRIPTION OF THE PREFERRED EMBODIMENT

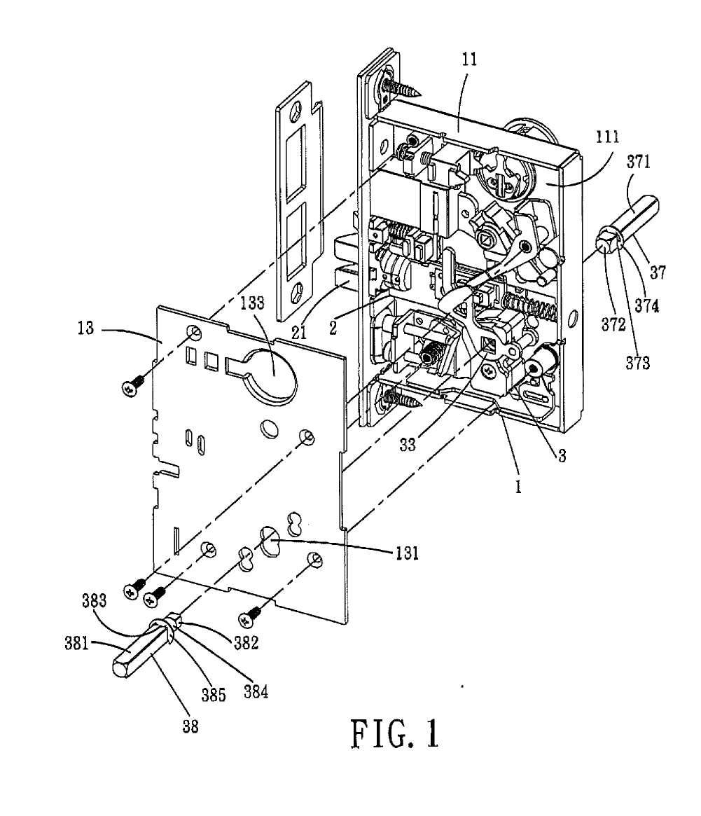

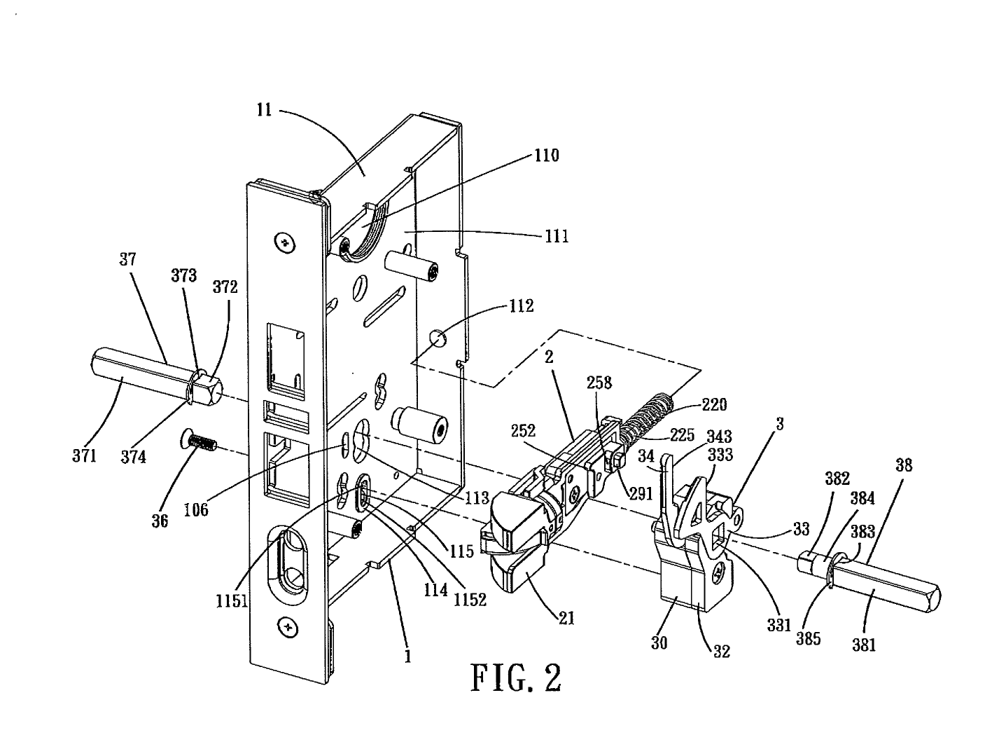

Referring to FIGS. 1 and 2, the preferred embodiment of a latch-bolt mechanism according to this invention includes a housing 1, a latch-bolt 2, and a distance-adjusting device consisting of a movable unit 3 and a fastener unit 36.

The housing 1 includes a housing body 11, and a cover plate 13 cooperating with the housing body 11 to define an accommodating space 111 therebetween. The housing body 11 has a spring-positioning stub member 112, a loop-shaped flange 114 defining a gourd-shaped hole 115 having upper and lower hole portions 1151, 1152, a driving-rod mounting hole 113 that is gourd-shaped, and a vertical slot 106. The cover plate 13 is formed with a driving-rod mounting hole 131 that is gourd-shaped and that is aligned with the driving-rod mounting hole 113 in the housing body 11.

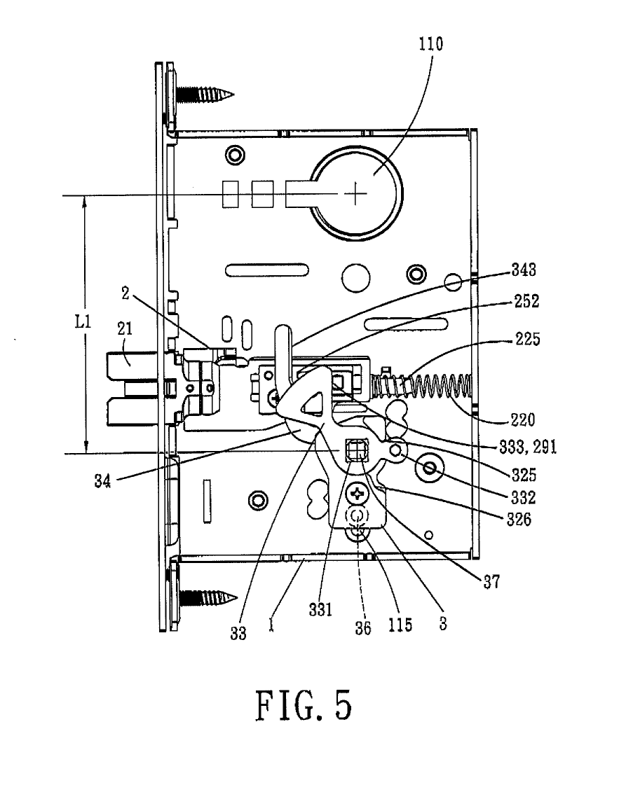

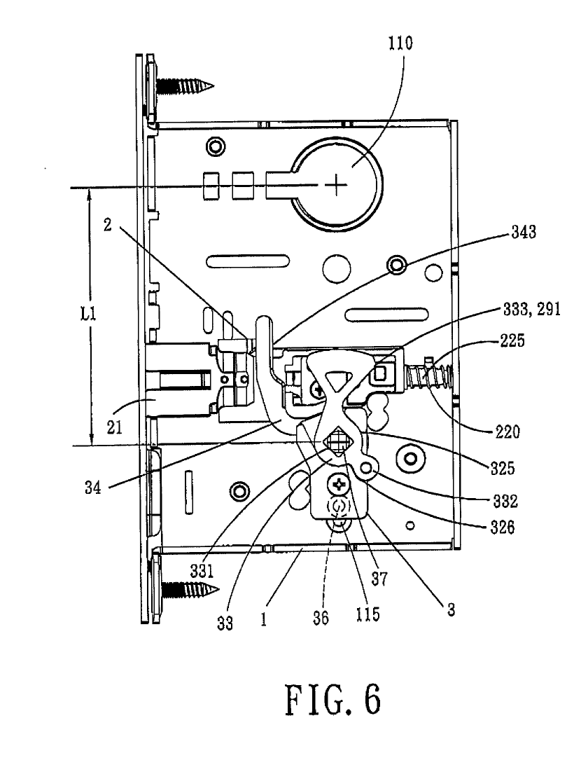

The latch-bolt 2 includes a bolt head 21 disposed at one end thereof, a projecting rod 225 disposed at the other end thereof, an engaging portion 291, a first driven portion 252, and a second driven portion 258, and is movable relative to the housing 1 between an extended position shown in FIG. 5, and a retracted position shown in FIG. 6. A coiled compression spring 220 (see FIG. 2) has an outer end sleeved on the projecting rod 225 for biasing the latch-bolt 2 toward the extended position.

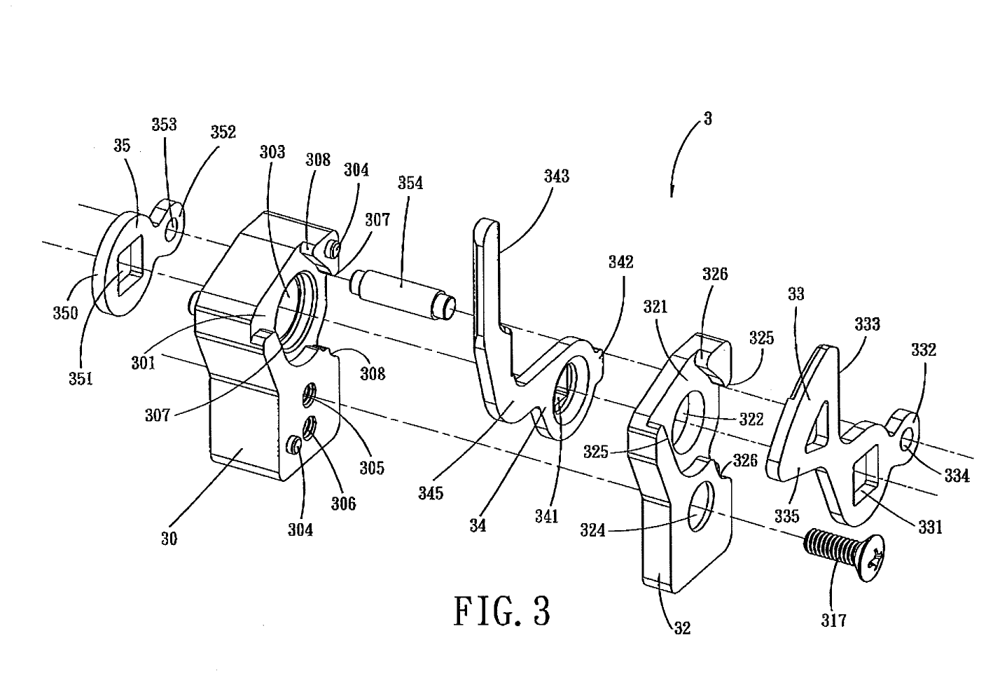

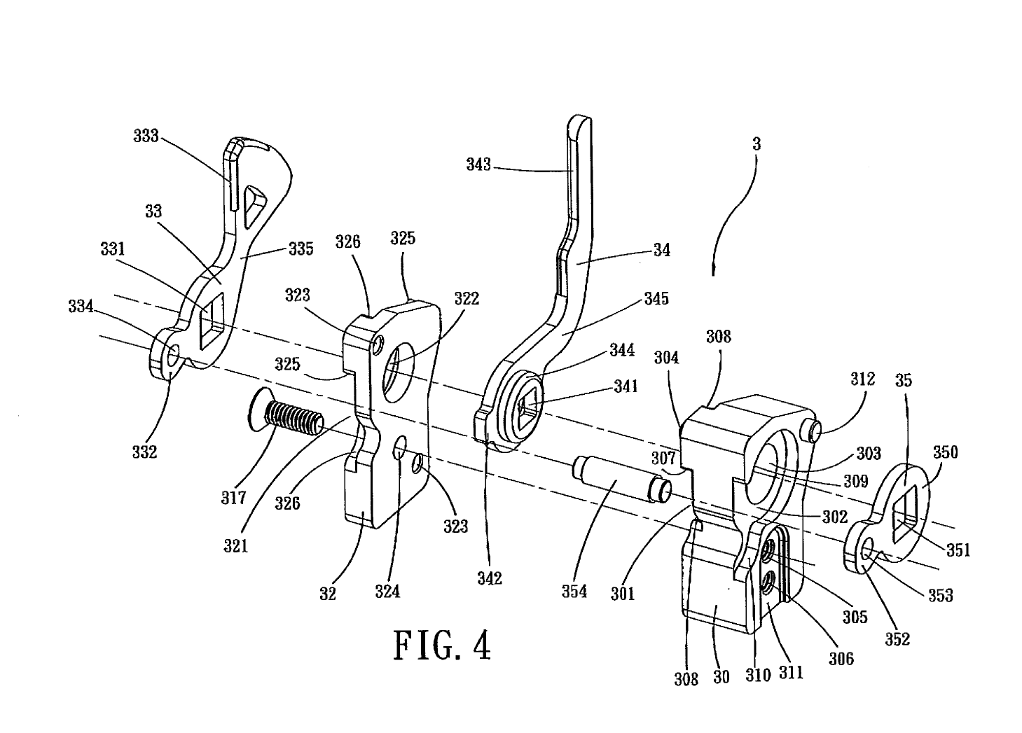

With further reference to FIGS. 3 and 4, the movable unit 3 includes a first mounting member 32, a second mounting member 30, a first drive member 33, a second drive member 34, a third drive member 35, a pin 354, and a bolt 317.

The first mounting member 32 has circular upper and lower holes 322, 324 formed therethrough. A side surface (see FIG. 3) of the first mounting member 32 has a first accommodating recess 321 in spatial communication with the upper hole 322, two first stop portions 325 adjacent to the upper hole 322 and located respectively at two sides of the upper hole 322, and two second stop portions 326 adjacent to the upper hole 322 and located respectively at two sides of the upper hole 322. An opposite side surface (see FIG. 4) of the first mounting member 32 has two pinholes 323.

The second mounting member 30 has a circular hole 303 formed therethrough, a first threaded hole 305, and a second threaded hole 306. A side surface (see FIG. 3) of the second mounting member 30 facing toward the first mounting member 32 has a second accommodating recess 301 in spatial communication with the circular hole 303, two third stop portions 307 adjacent to the circular hole 303 and located respectively at two sides of the circular hole 303, two fourth stop portions 308 adjacent to the circular hole 303 and located respectively at two sides of the circular hole 303, and two pins 304 engaging respectively the pinholes 323 in the first mounting member 32 for connecting the second mounting member 30 fixedly to the first mounting member 32. An opposite side surface (see FIG. 4) of the second mounting member 30 has a third accommodating recess 302, a slide slot 311 disposed under the third accommodating recess 302 and permitting the loop-shaped flange 114 of the housing 1 to be disposed slidably therein, a pair of fifth and sixth stop portions 309, 310 adjacent to the circular hole 303 and located respectively at two sides of the circular hole 303, and a guide pin 312 disposed slidably within the vertical slot 106 for guiding vertical movement of the second mounting member 30 relative to the housing 1. The slide slot 311 is in spatial communication with the first and second threaded holes 305, 306.

The first drive member 33 is configured as a cam, and has a portion disposed rotatably within the first accommodating recess 321 in the first mounting member 32. An end portion of the first drive member 33 has a rectangular hole 331 aligned with the upper hole 322 in the first mounting member 32, and a protrusion 332 disposed at a distal end thereof and having a pinhole 334. An opposite end portion of the first drive member 33 is configured as a swing arm 335 having a first driving portion 333. The swing arm 335 is rotatable to allow the first driving portion 333 to contact and push the engaging portion 291 of the engaging member 29 so as to move the latch-bolt 2 from the extended position to the retracted position when the engaging member 29 is disposed at an engagement position. Each of the protrusion 332 and the swing arm 335 is rotatable between the corresponding first stop portion 325 and the corresponding second stop portion 326 such that the rotational angles of the protrusion 332 and the swing arm 335 are limited.

The second drive member 39 is also configured as a cam, and has a portion disposed between the first and second mounting members 32, 30 and within the second accommodating recess 301 in the second mounting member 30. A lower end portion of the second drive member 34 has a rectangular hole 341 aligned with the upper hole 322 in the first mounting member 32 and the circular hole 303 in the second mounting member 30, a protrusion 342, and a loop-shaped flange 344 disposed rotatably within the circular hole 303 in the second mounting member 30 and defining the rectangular hole 341. A swing arm 345 is connected integrally to and disposed above the lower end portion of the second drive member 34, and has a second driving portion 343 that is rotatable to contact and push the first driven portion 252 of the latch-bolt 2 so as to move the latch-bolt 2 from the extended position to the retracted position. Each of the protrusion 342 and the swing arm 345 is rotatable between the corresponding third stop portion 307 and the corresponding fourth stop portion 308 such that the rotational angles of the protrusion 342 and the swing arm 345 are limited. As such, the first mounting member 32 is disposed between the first and second drive members 33, 34.

The third drive member 35 is configured as a rotary wheel, and has a wheel body 350 disposed rotatably within the third accommodating recess 302 in the second mounting member 30 and formed with a rectangular hole 351 at a central portion thereof, and a protrusion 352 extending outwardly from an outer periphery of the wheel body 350 and formed with a pinhole 353. The protrusion 352 is rotatable between the fifth and sixth stop portions 309, 310 such that the rotational angle of the protrusion 352 is limited. As such, the second mounting member 30 is disposed between the second and third drive members 34, 35.

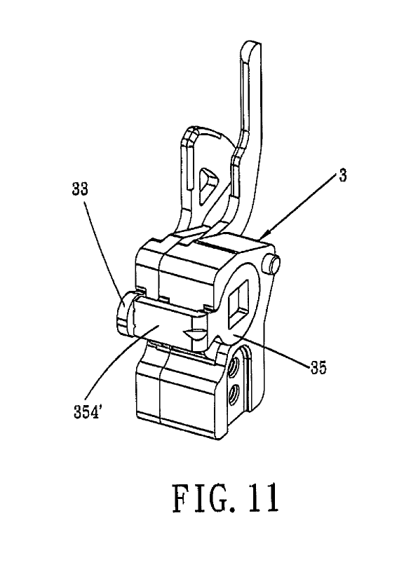

A pin 354 extends through and is secured within the pinholes 334, 353 in the first and third drive members 33, 35 so as to allow for synchronous rotation of the first and third drive members 33, 35. Alternatively, the pin 354 may be replaced with a connecting plate 354′ (see FIG. 11) that is connected integrally to the third drive member 35 and that is connected fixedly to the first drive member 33.

A bolt 317 extends through the lower hole 324 in the first mounting member 32 to engage the first threaded hole 305 in the second mounting member 30 so as to allow for synchronous vertical movement of the first mounting member 32, the second mounting member 30, the first drive member 33, the second drive member 34, the third drive member 35, the pin 354, and the bolt 317 relative to the housing 1. As such, a movable unit 3 (see FIG. 2) is constituted by the first mounting member 32, the second mounting member 30, the first drive member 33, the second drive member 34, the third drive member 35, the pin 354, and the bolt 317, and is movable vertically relative to the housing 1.

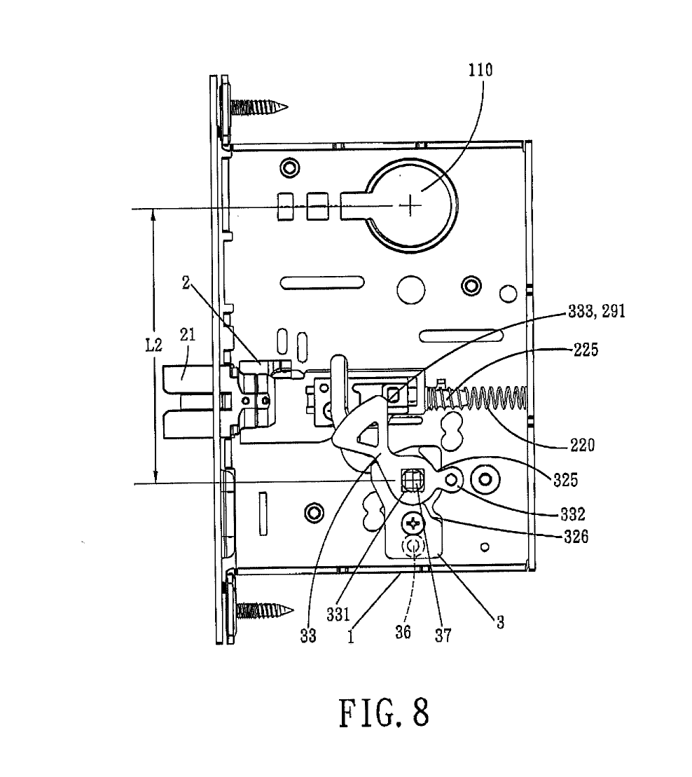

When the movable unit 3 is mounted to the housing 1, it can be driven to allow for relative movement of the flange 114 of the housing 1 within the slide slot 311 in the movable unit 3 and of the guide pin 312 of the movable unit 3 within the vertical slot 106 in the housing 1. As such, the movable unit 3 is movable relative to the housing 1 between a first vertical position shown in FIGS. 5, 6, and 7 and a second vertical position shown in FIGS. 8, 9, 10. In the first vertical position, a bolt 36 can be extended fittingly through the upper hole portion 1151 of the gourd-shaped hole 115 in the housing 1 to engage the second threaded hole 306 in the movable unit 3, so as to maintain the movable unit 3 at the first vertical position. In the second vertical position, the bolt 36 can be extended fittingly through the lower hole portion 1152 of the gourd-shaped hole 115 to engage the second threaded hole 306, so as to maintain the movable unit 3 at the second vertical position.

With particular reference to FIGS. 1 and 2, the movable unit 3 further includes a first driving rod 37 and a second driving rod 38.

The first driving rod 37 has an outer surface formed with an annular groove 373 to divide the first driving rod 37 into a first square-cross-sectioned rod portion 371 and a second square-cross-sectioned rod portion 372. A stop ring 374 engages the annular groove 373, is sleeved fixedly on the first driving rod 37, and is adjacent to a side surface of the third drive member 35 facing away from the second mounting member 30. The first square-cross-sectioned rod portion 371 is connected fixedly to an exterior handle (not shown). The second square-cross-sectioned rod portion 372 is engaged within the rectangular hole 351 in the third drive member 35 for driving the first drive member 33 when the exterior handle is operated.

The second driving rod 38 has a third square-cross-sectioned rod portion 381, a fourth square-cross-sectioned rod portion 382, an annular groove 383 disposed between the third and fourth square-cross-sectioned rod portions 381, 382, and a circular-cross-sectioned rod portion 384 disposed between fourth square-cross-sectioned rod portion 382 and the annular groove 383. A stop ring 385 engages the annular groove 383, is sleeved fixedly on the second driving rod 38, and is adjacent to a side surface of the first drive member 33 facing away from the first mounting member 32. The third square-cross-sectioned rod portion 381 is connected fixedly to an interior handle (not shown). The circular-cross-sectioned rod portion 384 is disposed within the rectangular hole 331 in the first drive member 33. The fourth square-cross-sectioned rod portion 382 is engaged within the rectangular hole 341 in the second drive member 34 for driving the second drive Member 34 when the interior handle is operated.

With particular reference to FIGS. 5, 6, and 7, when the movable unit 3 is disposed at the first vertical position, the axes of a lockset-mounting hole 110 and the first driving rod 37 are spaced apart from each other by a small distance L1 (i.e., 92 mm).

With particular reference to FIGS. 8, 9, and 10, when the movable unit 3 is disposed at the second vertical position, the axes of the lockset-mounting hole 110 and the first driving rod 37 are spaced apart from each other by a large distance L2 (i.e., 98.4 mm).

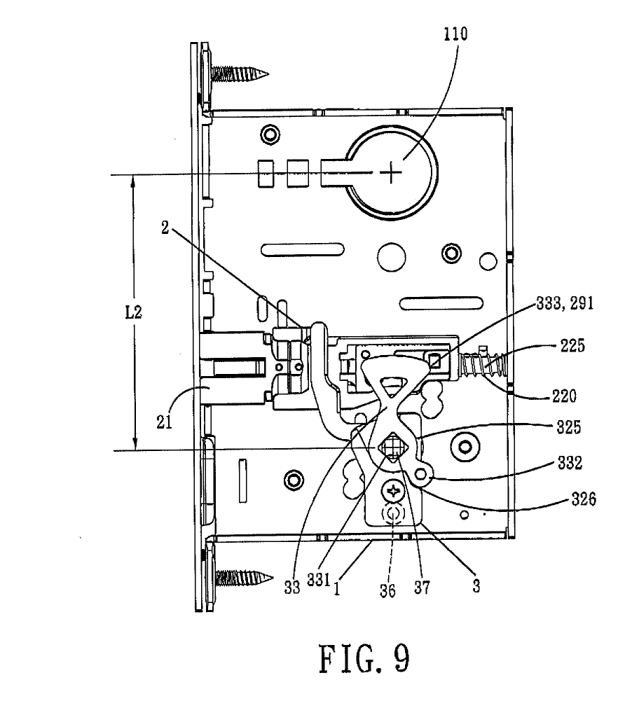

With particular reference to FIGS. 6 and 9, when the movable unit 3 is disposed at either the first or second vertical position, the latch-bolt 2 can be moved from the extended position to the retracted position by the first drive member 33.

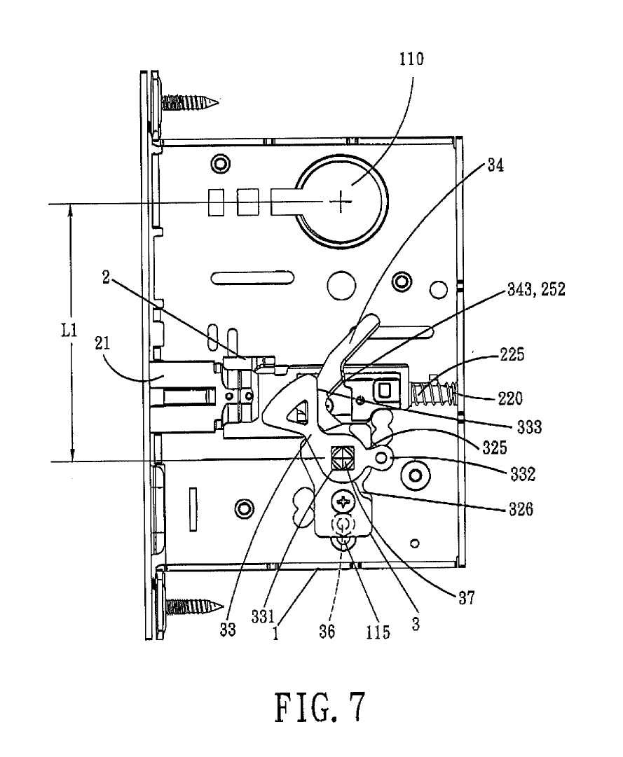

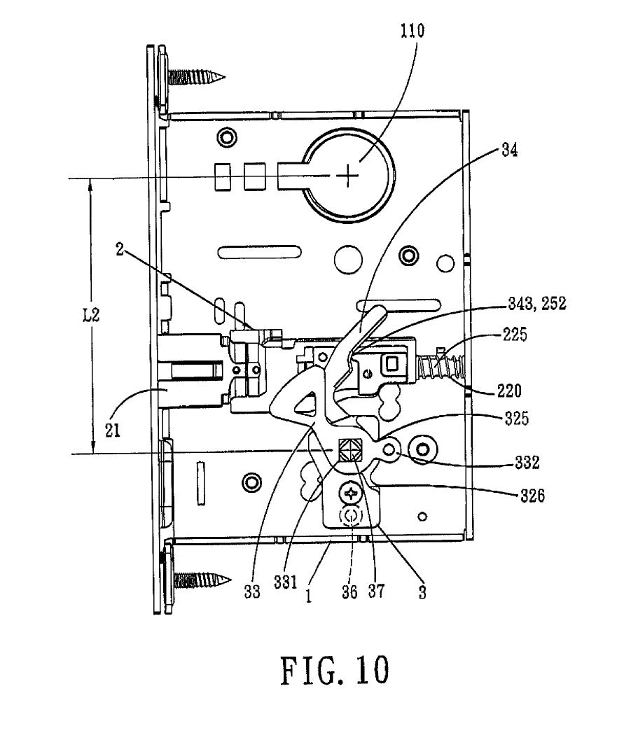

With particular reference to FIGS. 7 and 10, when the movable unit 3 is disposed at either the first or second vertical position, the latch-bolt 2 can also be moved from the extended position to the retracted position by the second drive member 34.

With this invention thus explained, it is apparent that numerous modifications and variations can be made without departing from the scope and spirit of this invention. It is therefore intended that this invention be limited only as indicated by the appended claims.

We claim:

1. A latch-bolt mechanism comprising:
a housing;
a latch-bolt movable relative to said housing between an extended position and a retracted position; and
a distance-adjusting device including
a movable unit movable in said housing between first and second vertical positions, said movable unit including a first drive member for driving movement of said latch-bolt from the extended position to the retracted position when said movable unit is disposed at either the first or second vertical positions, and
a fastener unit for locking said movable unit releaseably at a selected one of the first and second vertical positions.

2. The latch-bolt mechanism as claimed in claim 1, wherein:
said housing is formed with a hole having an upper hole portion and a lower hole portion disposed under said upper hole portion;
said movable unit is formed with a threaded hole; and
said fastener unit is configured as a bolt, said bolt extending fittingly through said upper hole portion to engage said threaded hole in said movable unit when said movable unit is disposed at the first vertical position, said bolt extending fittingly through said lower hole portion to engage said threaded hole in said movable unit when said movable unit is disposed at the second vertical position.

3. The latch-bolt mechanism as claimed in claim 2, wherein said hole in said housing is gourd-shaped.

4. The latch-bolt mechanism as claimed in claim 1, wherein said movable unit further includes a first mounting member, a second mounting member, a second drive member, and a third drive member, said first mounting member being disposed between said first and second drive members, said second mounting member being disposed between said second and third drive members.

5. The latch-bolt mechanism as claimed in claim 4, wherein said first and third drive members are movable synchronously with each other relative to said first and second mounting members, and said second drive member is movable relative to said first and second mounting members.

6. The latch-bolt mechanism as claimed in claim 5, wherein an assembly of said first and second mounting members has a first accommodating recess, a second accommodating recess, and a third accommodating recess, said first, second, and third drive members being disposed respectively and rotatably within said first, second, and third accommodating recesses such that rotational angles of said first, second, and third drive members are limited.

7. The latch-bolt mechanism as claimed in claim 6, wherein said latch-bolt has an engaging portion and a driven portion, said first and second drive members being rotatable relative to said housing to contact and push said engaging portion and said driven portion, respectively.

8. The latch-bolt mechanism as claimed in claim 1, wherein said movable unit is formed with a slide slot, and said housing is formed with a flange disposed movably within said slide slot in said movable unit.

9. A latch-bolt mechanism comprising:
a housing;
a latch-bolt movable relative to said housing between an extended position and a retracted position;
a movable unit movable in said housing between first and second vertical positions, said movable unit including a first drive member for driving movement of said latch-bolt from the extended position to the retracted position when said movable unit is disposed at either the first or second vertical positions; and
a fastener unit for positioning said movable unit at a selected one of the first and second vertical positions.

10. A latch-bolt mechanism comprising:
a housing;
a latch-bolt movable relative to said housing between an extended position and a retracted position;
a movable unit movable in said housing between first and second vertical positions, said movable unit including a first drive member for driving movement of said latch-bolt from the extended position to the retracted position when said movable unit is disposed at either the first or second vertical positions, and
a bolt for locking said movable unit releaseably at a selected one of the first and second vertical positions.
